(19) United States
(12) Patent Application Publication
(10) Pub. No.: US 2025/0238492 A1
(43) Pub. Date: Jul. 24, 2025

(54) IDENTITY INDICATION APPARATUS

(71) Applicants: Beijing Zitiao Network Technology Co., Ltd., Beijing (CN); Lemon Inc., Grand Cayman (KY)

(72) Inventors: Yan CAO, Los Angeles, CA (US); Keqi Shen, Beijing (CN); Lu Jin, Beijing (CN); Yingran Xu, Culver City, CA (US); Sydney Ng, Los Angeles, CA (US); Eugene Pivovarov, Los Angeles, CA (US); Xiaokun Liu, Los Angeles, CA (US); Patrick Liao, Los Angeles, CA (US)

(21) Appl. No.: 19/031,047

(22) Filed: Jan. 17, 2025

(30) Foreign Application Priority Data
Jan. 22, 2024 (CN) 202410090726.2

(51) Int. Cl. G06F 21/32

(52) U.S. Cl. CPC G06F 21/32

(57) ABSTRACT

Embodiments of the disclosure provide an identity indication apparatus. The identity indication apparatus includes: a housing comprising an identity indication portion adapted to present identity information; and an authentication component at least partially arranged in the housing and comprising an authentication mainboard and an interface portion coupled to the authentication mainboard, the interface portion being adapted to be connected to an external device so that the authentication mainboard communicates with the external device for authentication. The identity indication apparatus according to embodiments of the present disclosure combines an authentication component, such as a hardware key, with a housing, such as a name card holder.

### CROSS-REFERENCE

This application claims the benefit of Chinese Patent Application No. 202410090726.2 filed on Jan. 22, 2024, entitled “IDENTITY INDICATION APPARATUS”, which is hereby incorporated by reference in its entirety.

### FIELD

Embodiments of the present disclosure relate to the field of identity recognition, and more specifically, to an identity indication apparatus.

### BACKGROUND

Fast Identity Online Verification (FIDO2) is a new identity authentication protocol designed to enhance the security and convenience of user logins. Currently, there are several external authenticators that support FIDO2, which, through the principle of key hardware, achieve high security by generating internal public and private keys.

Currently, when using key hardware for authentication, users have reported that the current key hardware for FIDO2 authentication is inconvenient in terms of shape and size, making it prone to being forgotten or lost. While some small-sized key hardware can address the volume issue, it lacks differentiation from built-in fingerprint authentication devices, such as those on computers that require authentication. Additionally, these small-sized key hardware typically only feature a Type-C interface, which fails to meet the identity authentication needs of certain electronic devices.

### SUMMARY

A first aspect of the disclosure provides an identity indication apparatus. The identity indication apparatus comprises a housing comprising an identity indication portion adapted to present identity information; and an authentication component at least partially arranged in the housing and comprising an authentication mainboard and an interface portion coupled to the authentication mainboard, the interface portion being adapted to be connected to an external device so that the authentication mainboard communicates with the external device for authentication.

The identity indication apparatus according to embodiments of the present disclosure combines an authentication component, such as a hardware key, with a housing, such as a name card holder, enabling the user to carry the authentication component seamlessly. When login authentication is required, the interface portion can be connected to the external device requiring authentication, thereby completing the authentication process. In this way, it effectively enhances login security without adding any additional burden to the user and eliminates the risk of loss.

In some embodiments, the authentication component further comprises: a verification portion partially arranged outside of the housing or arranged to facilitate user operation, the verification portion being coupled to the authentication mainboard to verify a user's identity when the authentication mainboard performs the authentication.

In some embodiments, the verification portion comprises a biometric identification portion.

In some embodiments, the biometric identification portion comprises a fingerprint recognition portion.

In some embodiments, the verification portion comprises a button component for user pressing.

In some embodiments, the authentication component further comprises: a flexible connection portion adapted to couple the authentication mainboard and the interface portion, the flexible connection portion being arranged to at least partially surround the housing.

In some embodiments, the housing is in a shape of a sheet as a whole and further comprises: a cable accommodation groove formed in a circumferential wall of the housing for accommodating the flexible connection portion.

In some embodiments, the housing further comprises: an interface accommodation cavity arranged to communicate with the cable accommodation groove and comprising an opening portion formed in the circumferential wall of the housing for accommodating the interface portion in the interface accommodation cavity or removing the interface portion from the interface accommodation cavity.

In some embodiments, one of a plurality of walls of the housing forming the opening portion has a notch portion, and wherein the interface portion comprises an operation portion arranged to be positioned in the notch portion when the interface portion is accommodated in the interface accommodation cavity to facilitate user operation.

In some embodiments, the identity indication apparatus further comprises: an indication component arranged on the authentication mainboard for at least indicating a status relating to the authentication.

In some embodiments, the indication component comprises an indicator light, and the housing comprises an exposed portion for at least partially transmitting light emitted by the indicator light to outside of the housing.

In some embodiments, the identity indication portion comprises: a recessed portion for accommodating an identity indication card configured to present the identity information.

In some embodiments, the housing further comprises: a card fixing frame arranged to be coupled to the recessed portion for accommodating the identity indication card in the recessed portion.

In some embodiments, the identity indication apparatus further comprises: a portable portion adapted to be coupled to facilitate carrying the identity indication apparatus by a user.

In some embodiments, the authentication component further comprises: a Fast Identity Online Verification FIDO2 authentication chip arranged on the authentication mainboard for performing the authentication via a FIDO2 protocol.

In some embodiments, the interface portion comprises at least two of the following interfaces: a Type-C interface, a Lightning interface, a Mini-USB interface, a Micro-USB interface.

In some embodiments, the authentication mainboard is arranged in an accommodation space between the portable portion and the identity indication portion.

In some embodiments, the housing comprises: a bottom shell and a top shell coupled together through detachable connection.

### BRIEF DESCRIPTION OF DRAWINGS

A more detailed description of example embodiments of the present disclosure will be provided below with reference to the accompanying drawings. The above and other objectives, features, and advantages of the present disclosure will become more apparent. In example embodiments of the present disclosure, identical reference numerals generally represent the same components.

FIGS. 1 and 2 respectively show perspective views of the identity indication apparatus according to an embodiment of the present disclosure, observed from different angles;

FIG. 3 shows an exploded view of the identity indication apparatus according to an embodiment of the present disclosure; and

FIG. 4 shows a simplified view of the circuit of the identity indication apparatus according to an embodiment of the present disclosure.

### DETAILED DESCRIPTION

The following describes in greater detail exemplary embodiments of the present disclosure with reference to the accompanying drawings. Although certain embodiments of the present disclosure are shown in the drawings, it should be understood that the disclosure may be implemented in various forms, and should not be construed as limited to embodiments described herein. Rather, these embodiments are provided to facilitate a more thorough and complete understanding of the disclosure. It should be understood that the drawings and embodiments are for illustrative purposes only and are not intended to limit the scope of the protection of the disclosure.

In the description of the embodiments of the present disclosure, the term “comprises” and similar expressions should be understood as open-ended inclusion, i.e., “comprising but not limited to.” The term “based on” should be understood as “at least partially based on.” The term “an embodiment” or “the embodiment” should be understood as “at least one embodiment.” The terms “first,” “second,” and so on can refer to different or the same objects. The following may also include other explicit and implicit definitions.

The principles of the present disclosure will be described below with reference to several exemplary embodiments shown in the accompanying drawings. While the drawings show the preferred embodiments of the present disclosure, it should be understood that describing these embodiments is solely for the purpose of enabling those skilled in the art to better understand and implement the present disclosure, and should not be construed as limiting the scope of the disclosure in any way.

Fast Identity Online Verification (FIDO2) is a relatively new industry standard strong identity authentication protocol designed to enhance both the security and convenience of user logins. Under the FIDO2 verification protocol framework, two types of authenticators are supported: built-in authenticators (mainly biometric authentication like TouchID and FaceID) and external authenticators (security key hardware, also known as hardware keys).

Many hardware keys that support FIDO2 verification have already emerged in the market. The basic principle of hardware keys is that during the FIDO2 registration phase on the client, a public-private key pair is generated within the hardware key, and the public key is uploaded to the server via the client. During a login verification process on a certain client, the server transmits a random string to the client, which uses the hardware key to sign the random string and returns the result to the server for verification using the public key. Since the private key never leaves the hardware key itself, this verification process provides high security, effectively preventing phishing, man-in-the-middle attacks, and other network threats.

However, there are several issues with using hardware keys for authentication, primarily centered around the shape and size of the current hardware keys, making them inconvenient for daily use. Users are prone to forgetting or losing the hardware key. Although some smaller versions of hardware keys have been improved in size, they still have other drawbacks. First, they lack sufficient differentiation from built-in fingerprint authentication, such as that found on computers or mobile devices. Secondly, to achieve miniaturization, small hardware keys usually only feature a Type-C interface, which is unable to meet the needs of users requiring authentication on devices without Type-C interfaces.

An identity indication apparatus is provided according to an embodiment of the present disclosure, which combines an authentication component, such as a hardware key, with a housing, such as a name card holder, to address the inconvenience and other issues of traditional hardware keys. This apparatus also solves the deficiencies of small hardware keys in terms of differentiation and interface compatibility, achieving portability, high security, and wide compatibility to meet the diverse needs of users.

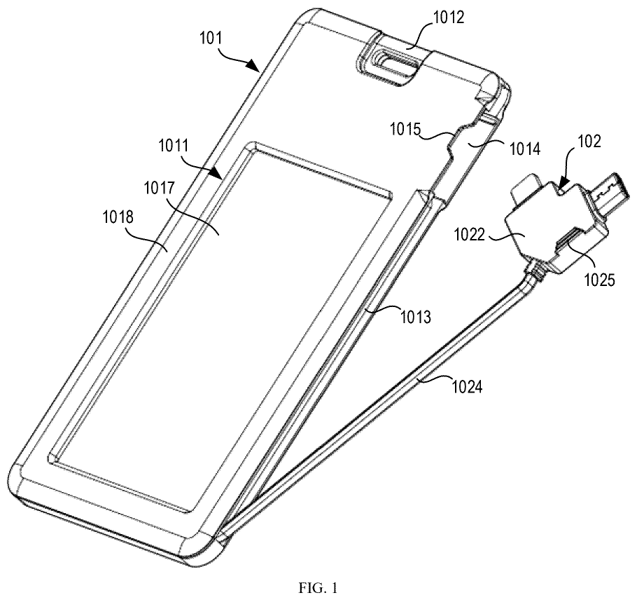

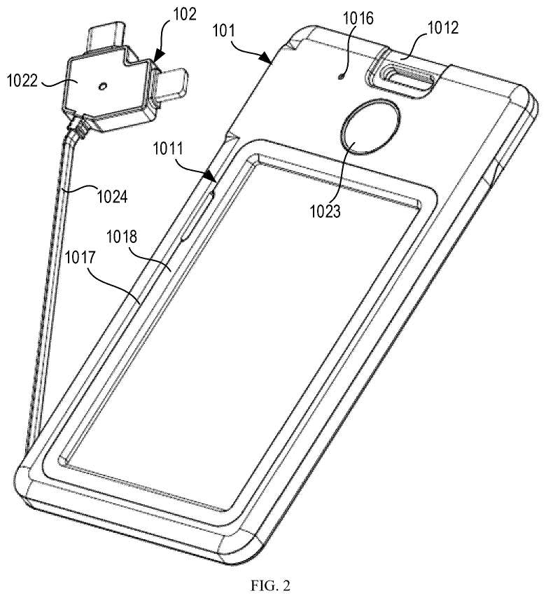

The following describes the identity indication apparatus according to an embodiment of the present disclosure with reference to FIGS. 1 to 4. FIGS. 1 and 2 respectively show perspective views of the identity indication apparatus from different angles, and FIG. 3 shows an exploded view of the identity indication apparatus. As shown in FIGS. 1 to 3, the identity indication apparatus according to an embodiment of the present disclosure generally includes a housing 101 and an authentication component 102. The housing 101 includes an identity indication portion 1011 that is adapted to present identity information. In some embodiments, the housing 101 may also include a portable portion 1012 that is adapted to be coupled in an appropriate manner to facilitate the user's carrying the identity indication apparatus. For example, in some embodiments, the housing 101 may be used as or referred to as a name card holder, which can accommodate a name card. Of course, it should be understood that the housing 101 can also serve as an identity indication for other appropriate contexts. The following will primarily use the example of the housing 101 as a name card holder to illustrate the concept of the present disclosure. It should be understood that the application of the identity indication apparatus in other scenarios is similar and will not be reiterated in the followings.

The housing 101 may generally be card-shaped and have any suitable shape. For example, the housing 101 may have the vertical rectangular shape shown in FIGS. 1 and 2, where the long sides of the rectangle extend in the vertical direction. In alternative embodiments, the housing 101 may also have a horizontal rectangular shape, with the long sides extending in the horizontal direction. Certainly, in some alternative embodiments, the housing 101 may have any other suitable shape.

In some embodiments, the housing 101 may include a bottom shell 1019 and a top shell 1010, which are coupled together by a detachable connection to facilitate the assembly of the identity indication portion 1011. The bottom shell 1019 and top shell 1010 may be coupled together by any suitable method, including but not limited to snap-fit connections, fastener connections, adhesives, and so on.

The identity indication portion 1011 may present identity information in an appropriate manner. For example, in some embodiments, the identity indication portion 1011 may include a recessed portion 1017 to accommodate an identity indication card 201, which is used to present identity information. The identity indication card 201 is used to present identity information such as a name, photograph, or other identifying information. For instance, the identity indication card 201 may be a name card or any other suitable card as mentioned above.

Of course, in some alternative embodiments, the identity indication portion 1011 may not include the recessed portion 1017 for accommodating the identity indication card 201, and the identity information may be presented by other suitable means. For example, the identity information may be printed directly on the surface of the identity indication portion 1011 or presented using methods such as e-ink and so on. In embodiments where the identity information is directly attached to the surface of the identity indication portion 1011 or presented using e-ink etc., the identity indication portion 1011 may be removably mounted to other parts of the housing 101 to facilitate replacement or adjustment of the identity information.

In some embodiments, the housing 101 may also include a card fixing frame 1018, which is arranged to be coupled to the recessed portion 1017 to accommodate the identity indication card 201 in the recessed portion 1017. This facilitates the assembly and replacement of the identity indication card 201. The card fixing frame 1018 may be coupled to the recessed portion 1017 by any suitable means, including but not limited to snap-fit connections, fasteners, adhesives, and so on. After being coupled to the recessed portion 1017, the card fixing frame 1018 will not obstruct the contents presented on the identity indication card 201. When a user needs to install or replace an identity indication card, such as a name card, the user only needs to remove the card fixing frame 1018, place the identity indication card 201 into the recessed portion 1017, and then reattach the card fixing frame 1018.

As mentioned earlier, in some embodiments, the portable portion 1012 is used to facilitate the user's carrying of the identity indication apparatus. For example, in some embodiments, the identity indication apparatus may also include a lanyard coupled to the portable portion 1012. The identity indication apparatus can be hung around the user's neck or placed in any other suitable position, making it easier for the user to carry the identity indication apparatus and reducing the likelihood of losing the apparatus. Of course, in some alternative embodiments, the portable portion 1012 may also be configured using clips, buckles, or other means to be attached to the user for easier carrying.

More importantly, as mentioned earlier, the identity indication apparatus according to embodiments of the present disclosure further includes an authentication component 102. The authentication component 102 is at least partially arranged in the housing 101 and includes an authentication mainboard 1021 and an interface portion 1022 coupled to the authentication mainboard 1021. When authentication is required for an action to be authenticated on an external device, the interface portion 1022 only needs be connected to the external device, enabling the authentication mainboard 1021 to communicate with the external device to perform the authentication. The actions to be authenticated may include any appropriate actions requiring authentication, including but not limited to user login, authorization, etc.

In some embodiments, the authentication component 102 may also include a Fast Identity Online Verification FIDO2 authentication chip. The FIDO2 authentication chip is arranged on the authentication mainboard 1021 to authenticate actions (e.g., user login) to be authenticated via the FIDO2 protocol. A specific example of the authentication process will be further elaborated below. Of course, it should be understood that the authentication component 102 may also use chips that support other existing or future-developed authentication protocols.

In some embodiments, the interface portion 1022 may include at least two of the following types of interfaces:
a Type-C interface, a Lightning interface, a Mini-USB interface, or a Micro-USB interface. For example, FIGS. 1 to 3 show that the interface portion 1022 may include both Type-C and Lightning interfaces, facilitating connection with most computers or mobile phones for authentication. In some embodiments, the interface portion 1022 may include male connectors of the aforementioned interfaces, which can be inserted into corresponding ports on external devices to complete the coupling between the identity indication apparatus and the external device.

In some embodiments, the authentication mainboard 1021 and the interface portion 1022 in the authentication component 102 may adopt an integrated structure, similar to that of a traditional hardware key. In such embodiments, the housing 101 may include an accommodation portion located between the portable portion 1012 and the identity indication portion 1011 (or any other suitable position). The authentication component 102 may be detachably arranged in the accommodation portion. When it is necessary to authenticate an action to be authenticated, the user only needs to remove the authentication component 102 and insert it into the external device to complete the authentication.

In some embodiments, as shown in FIGS. 1 to 3, the authentication component 102 may also include a flexible connection portion 1024. The flexible connection portion 1024 couples and connects the authentication mainboard 1021 and the interface portion 1022. For example, in some embodiments, the authentication mainboard 1021 is arranged in an accommodation space between the portable portion 1012 and the identity indication portion 1011, with the interface portion 1022 detachably accommodated in the housing 101. The flexible connection portion 1024 is arranged to at least partially surround the housing 101. The flexible connection portion 1024 not only enables signal connection between the interface portion 1022 and the authentication mainboard 1021 but also serves as a physical connector between them.

In this way, when the user needs to authenticate an action to be authenticated, they only need to remove the interface portion 1022 and insert it into the external device to complete the authentication. Since the interface portion 1022 is coupled to the authentication mainboard 1021 located in the housing 101 via the flexible connection portion 1024, that is, it corresponds to the interface portion 1022 remaining connected to the housing 101. This ensures that during the authentication process, the identity indication apparatus stays close to the user, effectively preventing the risk of the user forgetting to carry the authentication component 102 after the authentication is completed.

In some embodiments, to facilitate accommodating the flexible connection portion 1024, the housing 101 may further include a cable accommodation groove 1013 formed in the circumferential wall. When the interface portion 1022 is in the stored state, the cable accommodation groove 1013 can be used to accommodate the flexible connection portion 1024. In some embodiments, the flexible connection portion 1024 may also be accommodated within the housing 101 through telescoping or other mechanisms.

In some embodiments, the housing 101 may further include an interface accommodation cavity 1014. The interface accommodation cavity 1014 is arranged to communicate with the cable accommodation groove 1013 and includes an opening portion arranged in the circumferential wall of the housing 101. Through the opening portion, the user can insert the interface portion 1022 into the interface accommodation cavity 1014, and also remove it from the interface accommodation cavity 1014.

In some embodiments, to facilitate the removal of the interface portion 1022, one of a plurality of walls of the housing 101 forming the opening portion has a notch portion 1015, and the interface portion 1022 includes an operation portion 1025. The operation portion 1025 is arranged to be located in the notch portion 1015 when the interface portion 1022 is accommodated in the interface accommodation cavity 1014, allowing the user to easily operate it and remove the interface portion 1022.

In some embodiments, to authenticate the user's identity during the authentication process, the identity indication apparatus may also include a verification portion 1023. The verification portion 1023 is partially arranged on the outside of the housing 101. For example, in some embodiments, the verification portion 1023 may include a biometric identification portion such as a fingerprint recognition portion exposed on the outside of the housing 101. During the authentication process, when the user's identity needs to be verified, the user only needs to press their finger onto the fingerprint recognition portion to complete user identity verification. Of course, it should be understood that the biometric recognition portion may include other suitable biometric recognition components, in addition to or instead of the fingerprint recognition portion, such as biometric information recognition components using optical, biological, or biosensors to obtain user's biometric information for user identity verification.

In some embodiments, the verification portion 1023 may also include a button component. The button component is adapted to be pressed by the user to indicate that the user to be authenticated is near an external device that is performing user authentication action. After the user presses the button component, a short password input window will be presented on the external device's display, allowing the user to input the short password set during registration for user identity verification. In some embodiments, the button component may be partially arranged on the outside of the housing 101 for easy pressing by the user. In some alternative embodiments, the button component may be arranged in a predetermined position on the housing 101, where the user can press the predetermined position to realize the pressing of the button component by deforming the housing 101 elastically.

In some embodiments, the identity indication apparatus may further include an indication component 104. The indication component 104 is arranged on the authentication mainboard 1021 to at least indicate a status relating to the authentication. In some embodiments, the indication component 104 may include an indication light, and the housing 101 includes an exposed portion 1016 to allow light emitted by the indication light can pass to the outside of the housing 101. In some embodiments, the exposed portion 1016 may be a through-hole for the light emitted by the indication light to pass through. In some alternative embodiments, the exposed portion 1016 may be a transparent or semi-transparent portion that allows light emitted by the indication light to pass through to the outside. In some alternative embodiments, the indication component 104 may also include an audible component, such as a buzzer or speaker, or any other suitable indication component to indicate the authentication status.

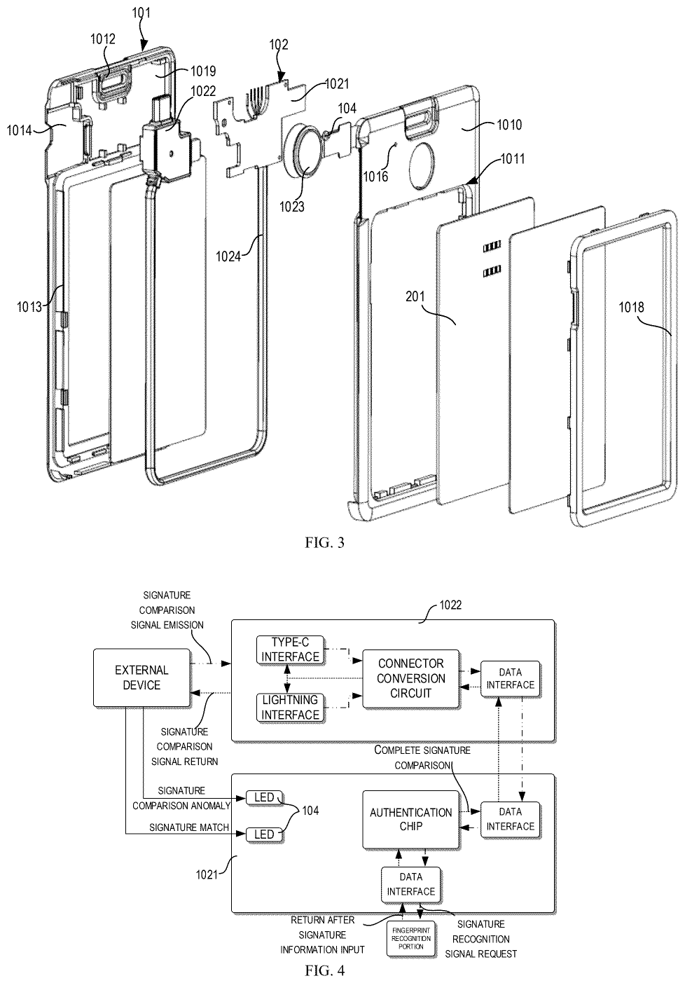

FIG. 4 illustrates the circuit structure of the identity indication apparatus according to embodiments of the present disclosure, as well as a schematic diagram of information transmission during the authentication process. The following will describe the specific registration and authentication processes with reference to FIG. 4.

### Registration Process

Insert the interface portion 1022: The user first inserts the Type-C or Lightning connector of the interface portion 1022 of the identity indication apparatus according to embodiments of the present disclosure into the port of an external device.

Open the FIDO2-compatible application: an application is opened on the external device that supports the FIDO2 protocol, initiating the registration process for FIDO2 verification.

Server sends registration request: The application sends a registration request for FIDO2 verification, and the server sends the request to the external device.

Fingerprint verification (using fingerprint recognition as an example): The fingerprint recognition portion of the external device verifies the user's identity. Once the user's identity is confirmed, the external device generates an asymmetric public-private key pair and stores it within the authentication chip of the authentication component 102. It should be understood that the authentication chip referenced in this registration process and the subsequent authentication process refers to the FIDO2 authentication chip mentioned earlier.

Upload the public key to the server: The external device uploads the generated public key to the server. After the server receives the public key, it stores it, completing the registration process.

### Authentication Process

When the user needs to perform an authentication action, such as user logging into an external device, they first insert the interface portion 1022 into the external device. During the user login process, the server generates a random string challenge and sends it to the external device performing the login. The external device then activates the authentication component 102 of the identity indication apparatus according to embodiments of the present disclosure, and prompts the user to use the fingerprint recognition portion for fingerprint verification.

Once the user successfully verifies their fingerprint, the authentication chip uses the stored private key to sign the challenge string generated by the server. The signed information is returned by the authentication chip to the external device and eventually uploaded to the server. The server verifies the signature using the user's previously stored public key. If the server successfully verifies the signature, it confirms that the user is in possession of the authentication component 102 corresponding to the private key in the public-private key pair generated during registration. Authentication is successful, and the user is granted access to login.

Through the detailed steps above, the identity indication apparatus according to embodiments of the present disclosure integrates a name card holder with a FIDO2 authentication device. This integration allows for convenient portability and identity information display, while its FIDO2 authentication chip ensures the security of the user's identity and the effectiveness of the authentication component 102 during the registration and authentication processes. The use of the public-private key pair enhances the system's security. This process greatly reduces the risk of phishing and man-in-the-middle attacks while providing a convenient and fast method for identity verification.

The above describes various embodiments of the present disclosure. The explanation provided is exemplary and not exhaustive, and is not limited to the disclosed embodiments. Without departing from the scope and spirit of the disclosed embodiments, many modifications and variations will be apparent to those skilled in the art. The terminology used herein is intended to best explain the principles of the embodiments, their practical applications, or technical improvements to technologies in the market, or to enable others skilled in the art to understand the embodiments disclosed in this document.

I/We claim:

1. An identity indication apparatus, comprising:
a housing comprising an identity indication portion adapted to present identity information; and
an authentication component at least partially arranged in the housing and comprising an authentication mainboard and an interface portion coupled to the authentication mainboard, the interface portion being adapted to be connected to an external device so that the authentication mainboard communicates with the external device for authentication.

2. The identity indication apparatus of claim 1, wherein the authentication component further comprises:
a verification portion partially arranged outside of the housing or arranged to facilitate user operation, the verification portion being coupled to the authentication mainboard to verify a user's identity when the authentication mainboard performs the authentication.

3. The identity indication apparatus of claim 2, wherein the verification portion comprises a biometric identification portion.

4. The identity indication apparatus of claim 3, wherein the biometric identification portion comprises a fingerprint recognition portion.

5. The identity indication apparatus of claim 2, wherein the verification portion comprises a button component for user pressing.

6. The identity indication apparatus of claim 1, wherein the authentication component further comprises:
a flexible connection portion adapted to couple the authentication mainboard and the interface portion, the flexible connection portion being arranged to at least partially surround the housing.

7. The identity indication apparatus of claim 6, wherein the housing is in a shape of a sheet as a whole and further comprises:
a cable accommodation groove formed in a circumferential wall of the housing for accommodating the flexible connection portion.

8. The identity indication apparatus of claim 7, wherein the housing further comprises:
an interface accommodation cavity arranged to communicate with the cable accommodation groove and comprising an opening portion formed in the circumferential wall of the housing for accommodating the interface portion in the interface accommodation cavity or removing the interface portion from the interface accommodation cavity (1014).

9. The identity indication apparatus of claim 8, wherein one of a plurality of walls of the housing forming the opening portion has a notch portion, and
wherein the interface portion comprises an operation portion arranged to be positioned in the notch portion when the interface portion is accommodated in the interface accommodation cavity to facilitate user operation.

10. The identity indication apparatus of claim 1, further comprising:
an indication component arranged on the authentication mainboard for at least indicating a status relating to the authentication.

11. The identity indication apparatus of claim 10, wherein the indication component comprises an indicator light, and
the housing comprises an exposed portion for at least partially transmitting light emitted by the indicator light to outside of the housing.

12. The identity indication apparatus of claim 1, wherein the identity indication portion comprises:
a recessed portion for accommodating an identity indication card configured to present the identity information.

13. The identity indication apparatus of claim 12, wherein the housing further comprises:
a card fixing frame arranged to be coupled to the recessed portion for accommodating the identity indication card in the recessed portion.

14. The identity indication apparatus of claim 1, further comprising:
a portable portion adapted to be coupled to facilitate carrying the identity indication apparatus by a user.

15. The identity indication apparatus of claim 1, wherein the authentication component further comprises:
a Fast Identity Online Verification FIDO2 authentication chip arranged on the authentication mainboard (1021) for performing the authentication via a FIDO2 protocol.

16. The identity indication apparatus of claim 1, wherein the interface portion comprises at least two of the following interfaces: a Type-C interface, a Lightning interface, a Mini-USB interface, a Micro-USB interface.

17. The identity indication apparatus of claim 1, wherein the authentication mainboard is arranged in an accommodation space between a portable portion and the identity indication portion.

18. The identity indication apparatus of claim 17, wherein the housing comprises:
a bottom shell and a top shell coupled together through detachable connection.
